(19) United States
(12) Patent Application Publication
(10) Pub. No.: US 2005/0263918 A1
(43) Pub. Date: Dec. 1, 2005

(54) Process for the manufacturing of filter elements as well as filter elements obtained in a such process

(75) Inventors: Steffen Heidenreich, Stimpfach (DE); Astrid Walch, Kressberg (DE); Martin Bergmann, Wunsiedel (DE)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY (US)

(21) Appl. No.: 11/194,533

(22) Filed: Aug. 2, 2005

Related U.S. Application Data
(63) Continuation of application No. PCT/EP03/01098, filed on Feb. 5, 2003.

(51) Int. Cl. B29C 45/00

(52) U.S. Cl. 264/41; 210/498; 210/348; 210/488; 425/542

(57) ABSTRACT

The present invention relates to a process for the manufacturing of a filter element having a porous body, said body comprising a bottom and a top portion, wherein said bottom and top portions define a cavity structure in between them, the cavity structure comprising an outlet for discharging filtrate having accumulated in the cavity structure. In order to avoid the laborious post-treatment or after-treatment of the filter body, the inventive process comprising forming a green filter element comprising powder injection molding said bottom portion in a first mold; opening the first mold; placing a core element on the bottom portion, said core element corresponding in its shape to the cavity structure of the body; powder injection molding said top portion onto said bottom portion and core element in a second mold; opening the second mold; and removing the so produced green filter element comprising the core element; and sintering the green filter element.

This application is a continuation application for international application No. PCT/EP03/01098 filed Feb. 5, 2003, which is incorporated herein by reference in its entirety and for all purposes.

### BACKGROUND OF THE INVENTION

The present invention relates to a process for the manufacturing of filter elements with a porous body, especially disk-shaped filter elements, said body being comprised of a bottom and a top portion, wherein said bottom and top portions define a cavity structure in between them, the cavity structure comprising an outlet for discharging filtrate having accumulated in the cavity structure. Furthermore, the present invention relates to a filter element obtainable in such a process.

For filtering of media, often times disk-shaped filter elements are used. Filter elements in the form of discoid filter plates are known for example from WO 01/85317 where the filter elements are designed for use in cross-flow filtration.

For that purpose a plurality of filter plates having a central through hole is assembled on a hollow shaft in stack form, the central through holes accommodating the hollow shaft. The filter plates are provided with a cavity structure in the form of inner filtrate drain channels which open into the interior of the hollow shaft for discharging the filtrate which has accumulated in the drain channels.

The filter plates disclosed in this publication comprise two body portions made from porous ceramic material which define in between them the filtrate drain channels. The two body portions are bonded together and are provided with at least one membrane filter layer on their external surface. The filter plates are fixedly connected to the hollow shaft and rotate together with the shaft during cross-flow filtration.

The stacks of filter plates are arranged in a housing to which the medium to be treated is delivered. The filtrate penetrates the pores of the ceramic material of the filter plates and is collected in the filtrate drain channels and drained into the interior space of the hollow shaft from where it is withdrawn. The portion of the medium to be treated which is retained and does not enter into the pores of the ceramic material is removed from the housing via a separate outlet.

In cross-flow filtration, as it is described in WO 01/85317 as well as WO 00/47312, the filter plates are provided in stack form on a plurality of hollow shafts and arranged in an inter-meshing configuration. When the shafts are driven rotatingly the filter plates of one stack move relative to the filter plates of one of the other stacks creating turbulences which remove solid particles deposited on the membrane's surfaces of the filter plates which results in longer operating times of the filter devices. Such operation requires high precision filter plates which are able to withstand considerable forces.

According to WO 01/85317 the filter plates may be produced by way of a slip casting process or, alternatively, by compressing dry powders.

In both processes, first of all, a filter element body is produced which includes the filtrate drain channels. After that the body is provided with a filtering layer on top of the outer surface.

According to both methods the bottom portion of the filter element body is manufactured first. On the bottom portion while still in the mold a mold core element is placed which serves for forming of the filtrate drain channels. Thereafter, the second body portion is produced on top of the bottom portion and the core element. Finally a filtering layer is provided on top of the surface of the body of the filter element.

When using the slip casting process, the core element is made of a material which evaporates upon heat ingress, e.g. waxes, camphor, fibrous webs or mats or microcellular rubber.

When dry powders are used and compressed, the core element is made of a material which evaporates or dissolves when higher temperatures and/or chemicals are applied.

Both processes have the disadvantage that they need an additional after-treatment for finalizing the filter plates especially to provide them with their final high precision shape.

### SUMMARY OF THE INVENTION

The object of the present invention is to provide a process for the manufacturing of filter plates of porous material including a cavity structure within said body for discharge of the filtrate which does not need laborious post-treatment or after-treatment. Furthermore, the object of the present invention resides in proposing filter bodies which are obtainable by such process.

The object of the present invention is met by a process comprising the steps of a) forming a green filter element comprising: powder injection molding said bottom portion in a first mold; opening the first mold; placing a core element on the bottom portion, said core portion corresponding in its shape to the desired cavity structure of the body; powder injection molding said top portion onto said bottom portion and core portion in a second mold; opening the second mold and removing the so produced green filter element comprising the core portion; and b) sintering the green filter element.

A basic aspect of the present invention resides in the use of a powder injection molding process. In a powder injection molding process a material, especially ceramic, plastic or metal powder, is admixed with a plastifier and eventually a binding agent to produce a moldable starting material. This starting material is fed into a mold at an elevated temperature. Preferably, the plastifier is selected such that it may serve simultaneously as the binding agent.

Often the filter elements of the present invention will be in a discoid form, especially when use in cross-flow techniques as hereinbefore described. The present invention is, however, not limited to such discoid structures, but is especially suitable for the manufacture of filter elements and filter bodies of any other shape, especially rather complex geometric design.

In case plastic, ceramic or metal powders are used in the starting material, the molded body produced in the injection molding process will be allowed to cool down and is then taken out from the mold. Such body is called a green body. After this step, the plastifier/binding agent of the starting material will be removed and the green body will thereafter be sintered.

In the powder injection molding process a very high quality of the surface is obtainable so that any after-treatment, like abrading or polishing, is not necessary. Likewise, high dimensional precision is obtainable without any after-treatment or post-treatment of the filter body. In addition, the inventive process provides for the possibility of manufacturing specific surface structures. Especially, an arbitrary and very complex internal and/or external design of the body may be realized in a flexible and cost effective manner. The inventive process, furthermore, allows for reduction of the percentage of scrap. Further, the filter elements produced show high resistance to mechanical stress, an important prerequisite if the filter element is to be used in cross-flow filtering techniques as described above.

According to a first specific embodiment of the present invention, the core element for providing a cavity structure will be produced. This core element will be placed on the bottom portion of the body while it is still in a green state and the top portion will then be injection molded.

The top portion of the body is produced while the bottom portion is still in the green state (and eventually prior to removing the plastifier/binding agent) resulting in a form-fit between the two portions, preferably to the extent that the two body portions behave like a unitary structure.

Depending on the desired cavity structure it may be advantageous to use a core element which consists of several core element portions which are not interconnected with one another. In other cases it may be preferred to use a unitary core element design.

In a further specific embodiment of the present invention the core element will be represented by hollow fibers which provide for the desired cavity structure. Preferably, in case of discoid filter plates the hollow fibers are arranged in radial directions running to the center of the disks.

Preferably, the hollow fibers are made of a material having the same chemical constitution as the filter body.

In another embodiment of the present invention the core element for providing a cavity structure in the filter body may be made of a soluble material, especially water-soluble material, which, after the injection molding process is terminated, may be dissolved by a solvent (e.g., water) and removed.

The material from which the core element is made may be shaped to the desired structure in compressing the powder in dry state to the desired form of the core element. Preferred materials are, for example, sugar or salt.

In still another embodiment of the present invention the core element may be made of a fine grained inert powder, e.g. fine sand, which is bound together by a soluble binder material. Preferably, it is a water-soluble binder material, especially a water-soluble carbohydrate, for example syrup or amylase. Such binding material will be dissolved by a solvent or especially water after the injection molding process and the inert powder material may then be removed by shaking the body or sucking out the disintegrated inert core element material. This has the advantage that only binding material is to be dissolved.

In a similar preferred embodiment of the present invention the core element is made of a fine grained inert powder material which is admixed with a binding material whereas the binding material evaporates or burns out at temperatures of 150° C. or above.

Binding agents which are favorable in this respect are for example polysaccharides, polyvinylalcohols, starch preparations and cellulose derivatives.

In contrast to the teaching of WO 01/85317 according to which the core element which is removed by heat ingress and evaporating the material, the afore-mentioned alternative yields in a much lower load of the oven exhaust air in the sintering stage, since only the portion of the binding material, but not the inert fine grain material or powder is to be removed and exits via the oven exhaust air.

During production it may be advantageous to, first of all, produce a core element made of a material having the same chemical composition as the bottom and top portion of the filter body will be made of and having itself a cavity structure which provides a filtrate drainage. Preferably, such core element will also be made by using the powder injection molding process as described above.

In such case, first of all, a lower portion of the core element will be manufactured in its green state and in this green state the upper portion will be injection molded onto it. Again by producing the upper portion while the lower portion is still in its green state and prior to removing the binding material, if necessary, form-fit between the upper and lower portion of the hollow core element will be accomplished.

In still another embodiment of the present invention a core element of coarse-grained porous material is placed on the bottom portion of the filter element. The average pore size preferably is in the range of 20 μm to 150 μm, more preferably in the range of 40 μm to 80 μm.

During injection molding of the top portion of the filter body a pressure will be simultaneously applied to such core element which serves to keep the pores of the coarse-grained porous material free and non-blocked. These pores offer the necessary cavity structure for collecting the filtrate and draining it. Preferably, the coarse-grained porous core element is made of a material of the same chemical composition as is the bottom and top portion of the filter element.

According to another alternative process of the present invention two powders of different particle sizes are injection molded whereas the first coarser powder is injected into the inner portion of the mold and the more finer powder is injected in the outer portions of the mold. Because of this, the coarse-grained material forms a core portion or core structure comprising coarse pores and the more fine divided particulate material forms the outer portions of the filter bodies.

It is advantageous that the finer grained powder has a particle size of from 5 μm to 50 μm, preferably from 10 μm to 35 μm, and for the more coarse powder the particle size ranges from 80 μm to 400 μm, preferably from 100 to 250 μm.

In accordance with a further alternative process the cavity structure is provided in that gas is injected into the mold of the filter element in a predefined area which serves to keep certain hollow spaces free. The gas will be injected through a plurality of nozzles during the injection molding process into the mold in order to provide the desired cavity structure.

Preferably, the clearing of the hollow portions representing the cavity structure by gas injection during injection molding will be enhanced by rib-like projections on the surface of the mold used. Because of the rib-like structure more thicker and more thinner areas of the body will formed. The gas used for clearing out or providing the hollow portions in the inner of the mold will preferably be directed to the more thicker portions and will increasingly produce hollow portions in these areas.

A major advantage of the present invention resides in avoiding the disadvantages accompanied by the use of a so-called lost core structure made from a material which is dissolved or evaporates when the temperature is increased, for example fiber mats or webs, expanded rubber or waxes as it is described in WO 01/85317. The use of such type of lost core structure includes the risk that upon pressurizing the filter body the material of the core structure will elastically deform, while after removing the pressure resulting from the molding process itself the restoring force of the core structure will act which is sufficient to produce fissures or cracks in the filter body. This, in the end, is responsible for a high scrap rate.

In the powder injection molding technique generally two different types of processes are distinguished. The first one is called hot-molding or low pressure injection molding and the other one is the injection molding in the real sense.

When injection molding one uses a plastifier and eventually a binding agent selected from thermoplastic or duroplastic resins and mixes the same with a sintering powder to a viscous meltable mass (viscosity approximately 100 to 1000 Pas).

The sintering powder will be mixed in a heated kneader together with the plastifier/binding agent and afterwards granulating the mass. Aside from the plastifier/binding agent, in addition, softening and slipping agents may be present. The mixture for injection molding will be used in injection molding machines for producing the moldings (filter bodies). This process is carried out at temperatures of approximately 120 to 200° C. at an operating pressure of typically 50 MPa or more. For removing the plastifier/binding agent from the green bodies, they have to be heated up to a temperature which depends on the nature of the plastifier/binding agent used. When polyolefin-based plastifier/binding agents are used, one typically heats the green body to a temperature of 150 to 170° C. in a first step and to approximately 300° C. in a second step.

Because of the high pressures and temperatures applied the molds have to be made of steel and alike. Therefore, injection molding is useful only when articles are to be produced in high numbers which justifies the high cost for such type of molds.

If only a low number of articles is produced a so-called hot-casting process is preferred. When hot-casting, the sintering powder and plastifier/binding agent on the basis of for example paraffin or other waxes are mixed in a heated ball mill. The mixture produced thereby will be directly fed into a cooled mold where the mixture solidifies as the casting. The temperatures used in this process typically are in the range of 60 to 100° C. and the pressure applied typically is in the range of 0.2 to 5 MPa. When removing the plastifier/binding agent it is not necessary to heat the molding to temperatures above 250° C. Because of the relatively mild pressure and temperature conditions silicon based molds can be used. These molds also allow a more complicated design.

A detailed description of the powder injection molding and hot-casting technology is found in “Technische keramische Werkstoffe”; Ed. Jochen Kriegesmann, chapters 3.4.8.0 and 3.4.8.1, Deutscher Wirtschaftsdienst, Köln, 1995.

Preferably, on the outer surface of the filter body, at least one filtration layer is provided. Preferably, it is a fine porous membrane. This membrane can be made of one or several layers and is usually, compared with the dimensions of the filter body, very thin. Such membranes may be made on the basis of alumina, silicon carbide, titanium dioxide, silica, zirconia, calcium aluminate, zeolithe and/or alumosilicate. Alumina, silicon carbide and silica are useful also for the manufacturing of the filter body itself. The membrane has preferably an average pore size in the range of 0.005 μm to 1.2 μm.

The filter bodies according to the present invention may have various cavity structures. The cavity structure of the inventive filter bodies may be a continuous, i.e., an interconnected or unitary structure which, for example, opens to a hollow space in the center of the plates, or it can be designed as a plurality of cavities which lead to a common outlet, e.g., a central opening of the filter plate.

Especially for use in devices for cross-flow filtration using rotating filter bodies it may be advantageous to use a sort of spiral like cavity structure. This can be realized by radially extending, curved ridges.

Preferably, the process of the present invention is carried out such that after the bottom portion of the filter body has been formed in a first mold the upper half of the first mold is removed, the bottom portion is retained in the lower half of the first mold, the core element is placed on the bottom portion and then the closed mold is provided while this time a further upper mold half is used which complements the lower half of the first mold so as to form the second mold accommodating the whole body of the filter element.

The invention is further illustrated by way of several examples and the accompanying drawings.

### BRIEF DESCRIPTION OF THE DRAWINGS

FIGS. 1a and 1b: A filter body according to a first embodiment of the present invention;

FIGS. 2a and 2b: A filter body according to a further embodiment of the present invention;

FIG. 3a: A mold for manufacturing a filter body according to the present invention; and

FIG. 3b: A filter body produced using the mold shown in FIG. 3a.

### DETAILED DESCRIPTION OF THE INVENTION

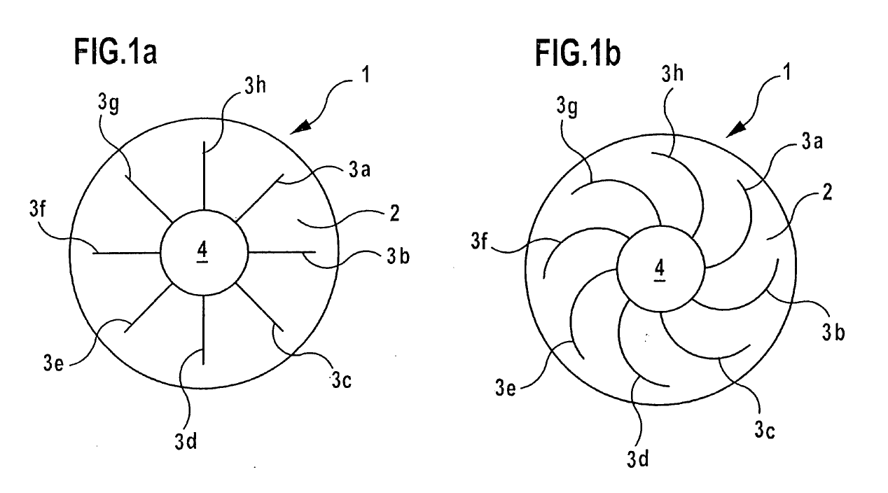

FIG. 1a shows an embodiment of the present invention in the form of a discoid filter element 1 in schematic cross section. The filter element 1 comprises a cavity structure 2 of interconnected voids volumes which are partly separated from one another by radially extending ridges 3a through 3h. The filter element 1 has a central through hole 4 which serves to receive a hollow shaft which functions as a conduit for filtrate received from the filter element and its cavity structure, respectively. The ridges 3a through 3h start at the central through hole 4 and run in direction to the parameter of the filter element, but stop short in a certain distance from the parameter so as to provide a connection between neighboring voids volumes separated by the ridges so that each voids volumes are interconnected with one another and forming the cavity structure 2.

FIG. 1b shows an alternative embodiment of a filter element 1 having a design similar to that of FIG. 1a. The difference in these two embodiments resides in the geometry of the ridges 3a through 3h. The ridges 3a through 3h of FIG. 1b show a curved design which will assist drainage of the filtrate from cavity structure 2 when the discoid filter element 1 is rotated during operation by imparting a moment in the direction to the through hole 4 to the filtrate fluid. This moment is counteracting the centrifugal forces exerted on the filtrate fluid when the discoid filter element is made to rotate.

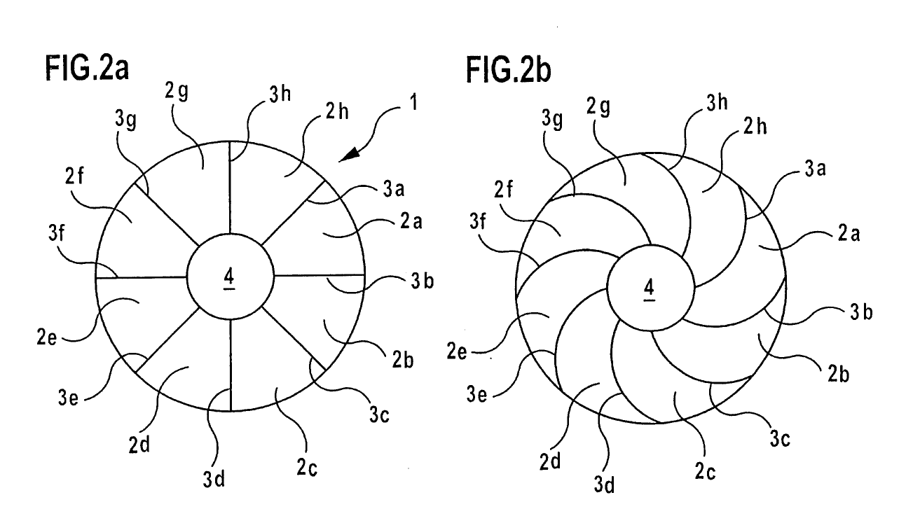

The design shown in FIGS. 2a and 2b differ from the embodiments described in connection with FIGS. 1a and 1b, respectively, in that the ridges 3a through 3h start from the through hole 4 and now extend to the parameter of the discoid shaped filter element 1. Thereby, individual and separated voids volumes 2a through 2h are created which are not interconnected with one another, but just open to the through hole 4 which again receives a hollow shaft which serves as a conduit for the filtrate fluid.

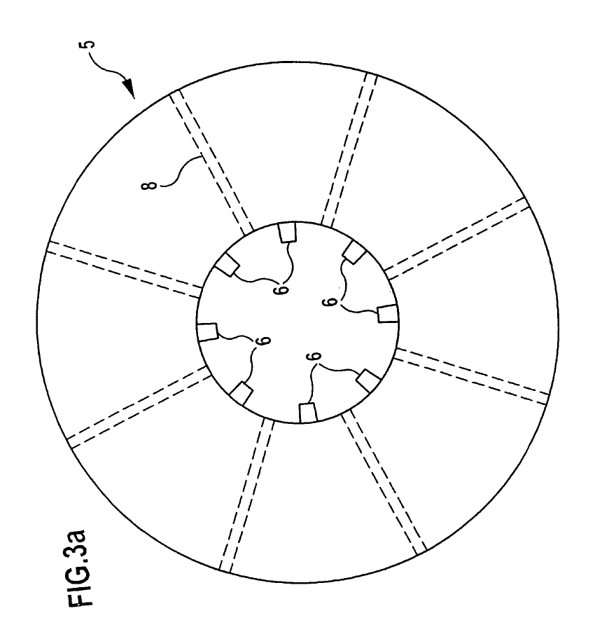

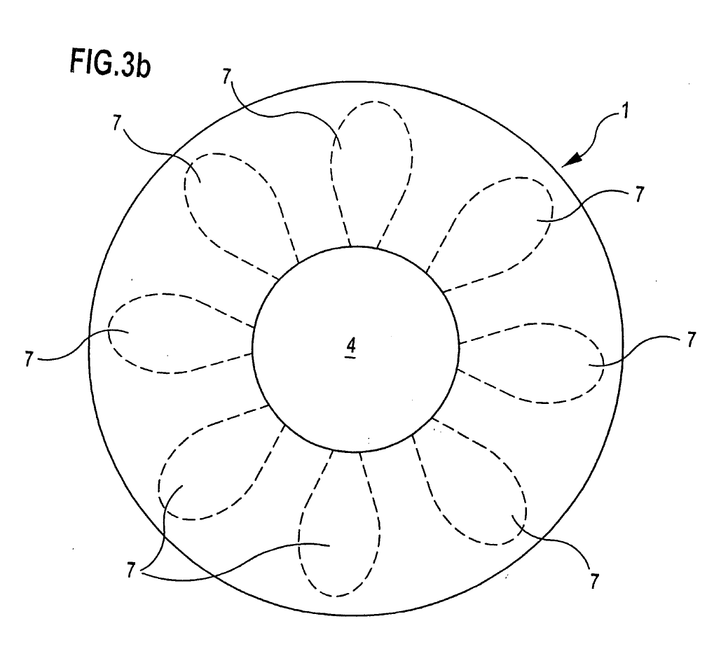

FIG. 3a shows the design of a mold 5 which is defined for producing discoid shaped filter elements according to the present invention. The mold 5 has a central through hole where in a number of equidistantly arranged injection nozzles 6 are arranged which allow injection of gas into the mold. During the injection molding process for forming the filter body simultaneously gas will be injected in parallel to the injection of the powder material. The areas where the gas is injected the powder material used in the powder injection molding process may not deposit, therefore leaving voids volumes which create the necessary cavity structure. The result is shown schematically in FIG. 3b. The filter element 1 produced according to this specific embodiment of the present invention incorporates within the body of filter element 1 a number of voids volumes 7 are created which are regularly arranged around the central opening 4 of the filter element and which are in fluid connection with the through hole 4. Through hole 4 is again designed to receive a hollow shaft which allows drainage of the filtrate fluid from the voids volumes 7.

In the mold 5 as shown in FIG. 3a ridges 8 are formed so as to narrow the inner space of the mold in these portions allowing to direct the gas injected through nozzles 6 to confined areas which correspond to the voids volumes 7. Thus, the ridges 8 not only direct the gas injected via nozzles 6, but also prevent that the cavities 7 will become too big. When the filter element 1 is taken from the mold 5, on the surface notches will be observed which correspond to the ridges 8 of the mold. In some cases it might be desirable to have a flat outer surface of the filter body and in such cases these notches may be filled in a separate step with sintering material prior to removing the binding agent and sintering the green filter body.

### EXAMPLE 1

A sinterable powder (Al₂O₃ powder of 30 μm average particle size) is admixed with a plastifier/binding material on polyolefin basis in a compounder and granulated. Such plastifier/binding material is preferred since it may be removed in two steps.

The bottom portion of the filter element is injection molded (cylinder temperature approx. 140-150° C.) in a first (closed) mold. The equipment used for the injection molding process was a machine type Allrounder 820S (Arburg GmbH+Co., Loβburg, Germany). The upper portion of the first mold is removed. The portion remains in the lower portion of the first mold.

On top of this bottom portion a core element made of compressed sugar or salt is placed. The second mold is formed by complementing the lower portion of the first mold with another upper portion, and the top portion of the filter element is injection molded using the material described above. By this process a green body is produced which in a first step will be washed with water which results in dissolution of the core portion or core element, and in a second step it will be heated up to 160° C. and 300° C. for removing the binding agent. After that the sintering step (sintering temperature approximately 1750° C.) follows to yield the finalized filter body.

Typically, the body of the discoid filter element has a thickness of 6 mm, while the thickness of the core element used in cross-low filtration is approximately 1.5 mm. A typical diameter of the discoid filter element is 200 mm.

The core portion made of sugar or salt is formed such that the discoid filter body 1 (cf. FIGS. 1a and 1b) has an central opening 4 to receive a hollow shaft. This structure is used in a cross-flow filtering process where the hollow shaft is rotated together with the filter body 1. The cavity structure is constituted of interconnected voids volumes, partly separated from one another by ridges 3a to 3h.

### EXAMPLE 2

The core element in this example is made of a mixture of quartz powder (average particle size 50 μm) admixed with syrup or a starch preparation based on amylase as a binding material. While the particle size is not critical it is preferably selected to be 50 μm in the average.

The injection molding powder used is constituted of a sintering powder material and a plastifier/binding agent (cf. Example 1) which may be removed by heating only. The syrup or starch preparation contained in the core element will be washed out prior to removing the binding agent from the injection molding powder. Once the syrup or starch preparation is dissolved, the quartz powder may be removed from the cavity in loose form.

Such portions of the core binding material which may not have been dissolved during the washing of the green body will be burnt out during heating of the green body when removing the binding agent. In case of the above-mentioned ingredients it is also possible to skip the washing step and to remove the binding agent of the core element by burning out only. Prior to the sintering of the filter body, the quartz powder resulting from the disintegrated core element is removed.

With respect to further treatment, reference is made to example 1.

### EXAMPLE 3

A bottom portion of a filter element is injection molded according to Example 1 and a coarsely porous core element is placed on the bottom portion. For producing the core element an Al₂O₃ powder with an average particle size in the range of 100 to 200 μm is used.

The further manufacturing process for a filter element follows the process as described in Example 1.

In contrast to the filter element in Example 1 the core element remains permanently in the filter body and the voids volume of the core element represents the cavity structure of the body of the filter element.

### EXAMPLE 4

The manufacturing process according to this example corresponds to Example 3 with the proviso that the core element is in the form of hollow (ceramic) fibers which also consist of alumina and which are arranged in radial directions. Fibers which may be used are for example known from A. Goldbach et al., Keramische Zeitschrift 53 (2001), pages 1012 to 1016.

Suitable hollow ceramic fibers have an outer diameter of preferably less than 1 mm, more preferably of approximately 0.6 mm. The thickness of the wall of the hollow fibers preferably is in the range of 50 to 100 μm. Such dimensions especially apply for filter elements used in the cross-flow filter technique described above.

On top of the filter body a filtration layer made of titanium dioxide (see for example DE 195 03 703 A1) having an average pore size of 0.01 μm and 0.05 μm is deposited.

For further details see the process described in Example 1.

### EXAMPLE 5

In a process analogous to Example 4 on top of the surface of the filter plate, additionally, a filtration layer of zirconia is deposited, the zirconia having an average particle size of from 0.05 μm to 0.1 μm.

### EXAMPLE 6

In a process analogous to Example 4 after sintering of the green body the outer surface of the filter body 1 is covered by a fine porous membrane made of alumina having an average pore size of from 0.5 to 1.0 μm.

1. A process for manufacturing a filter element having a porous body, said body comprising a bottom portion and a top portion, wherein said bottom and top portions define a cavity structure in between them, the cavity structure comprising an outlet for discharging a filtrate having accumulated in the cavity structure, said process comprising:
a) forming a green filter element comprising:
powder injection molding said bottom portion in a first mold;
opening the first mold;
placing a core element on the bottom portion, said core element corresponding in its shape to the cavity structure of the body;
powder injection molding said top portion onto said bottom portion and core element in a second mold;
opening the second mold; and
removing the so produced green filter element comprising the core element; and
b) sintering the green filter element.

2. The process according to claim 1, wherein the filter element has the shape of a disk.

3. The process according to claim 1, wherein the outlet of the cavity communicates with a central opening of the filter element.

4. The process according to claim 1, comprising placing a core element having two or more core element portions on the bottom portion.

5. The process according to claim 1, comprising placing a core element having hollow fibers on the bottom portion.

6. The process according to claim 5, wherein the hollow fibers are arranged in a predetermined pattern on the bottom portion.

7. The process according to claim 1, wherein the core element is formed from a material which may be dissolved in a solvent.

8. The process according to claim 1, wherein the core element is formed from an inert fine grain material and a soluble binding agent.

9. The process according to claim 8, wherein the binding agent is a water soluble agent.

10. The process according to claim 1, wherein the core element is made from an inert fine grain material and a binding agent which evaporates and/or burns out at temperatures of 150° C. or above.

11. The process according to claim 1, wherein the core element itself is powder injection molded and placed on the bottom portion in a green state.

12. The process according to claim 1, wherein the core element is made from a material having coarse pores.

13. The process according to claim 11, wherein during powder injection molding of the top portion the core element is pressurized by a gas source.

14. A process for manufacturing a filter element having a body of a porous structure, said body including a cavity, said process comprising:
a) forming a green filter element comprising:
powder injection molding the filter element in a mold by simultaneously injecting two different powder materials, the first material being injected into the inner portion of the mold to form a core element, the second material being injected into the mold such as to form an exterior wall portion surrounding the core element;
removing the green filter element from the mold; and
b) sintering the green filter element.

15. A process for the manufacturing of a filter element having a body of a porous structure, said body including a cavity for collecting filtrate, said process comprising:
a) forming a green filter element comprising:
powder injection molding the body of the filter element in a mold while simultaneously injecting gas into predefined areas of the mold to form a cavity structure;
removing the green filter element from the mold; and
b) sintering the green filter element.

16. The process according to claim 1, wherein the mold used in the powder injection molding step has a grooved surface portion.

17. The process according to claim 1, wherein the powder injection molding is performed as hot casting.

18. The process according to claim 1, wherein the filter element has an outer surface and a filtration layer is applied on top of the outer surface of the filter element.

19. The filter element obtained by the process according to claim 1.

20. The filter element according to claim 19, wherein the filter element has the shape of a disk.

21. The filter element according to claim 20, wherein the disk-shaped filter element comprises a central through hole, said cavity within the body of the filter element being in unobstructed fluid connection with the central through hole.

22. The filter element according to claim 19, wherein the cavity comprises a plurality of interconnected voids volumes.

23. The filter element according to claim 22, wherein the voids volumes are interconnected via the central through hole of the filter element.

24. The filter element according to claim 22, wherein the voids volumes are radially extending from the central through hole.

25. The filter element according to claim 22, wherein each voids volume follows a curved path.
